(19) United States
(12) Patent Application Publication
(10) Pub. No.: US 2015/0294796 A1
(43) Pub. Date: Oct. 15, 2015

(54) ASSEMBLIES AND METHODS OF STABILIZATION

(71) Applicants: THE UNIVERSITY OF NORTH CAROLINA AT CHAPEL HILL, Chapel Hill, NC (US); NORTH CAROLINA STATE UNIVERSITY, Raleigh, NC (US)

(72) Inventors: Kenneth Hanson, Tallahassee, FL (US); Thomas J. Meyer, Chapel Hill, NC (US); Gregory N. Parsons, Raleigh, NC (US); Mark D. Losego, Atlanta, GA (US); Berc Kalanyan, Raleigh, NC (US); Do Han Kim, Melrose, MA (US)

(73) Assignees: North Carolina State University, Raleigh, NC (US); The University of North Carolina at Chapel Hill, Chapel Hill, NC (US)

(21) Appl. No.: 14/646,047

(22) PCT Filed: Nov. 21, 2013
(86) PCT No.: PCT/US13/71199

§ 371 Date: May 20, 2015

Related U.S. Application Data
(60) Provisional application No. 61/729,059, filed on Nov. 21, 2012.

(51) Int. Cl. H01G 9/20; C25B 1/00

(52) U.S. Cl. CPC H01G 9/2036; C25B 1/003; H01G 9/2031

(57) ABSTRACT

Some embodiments of the present invention provide an assembly for harvesting light comprising a first molecule joined to a metal oxide surface through a surface linking group and a second molecule joined to the metal oxide surface. Such assemblies can harvest light to do useful chemistry, such as in a dye-sensitized photoelectrochemical cell, or a molecular catalyst-solar cell system. In other embodiments, the harvested light can be converted into electricity, such as in a dye-sensitized solar cell. Other embodiments of the present invention provide methods for stabilizing a chromophore or a catalyst on a surface. These methods are applicable, for example, to dye-sensitized photoelectrochemical cells where the surface-bound chromophores are known to be unstable under aqueous conditions.

### CROSS REFERENCE TO RELATED APPLICATIONS

This international application claims benefit of priority to U.S. Provisional Patent Application Ser. No. 61/729,059, entitled, “ASSEMBLIES AND METHODS OF STABILIZATION,” filed on Nov. 21, 2012, the disclosure of which is incorporated herein by reference in its entirety.

### STATEMENT REGARDING FEDERALLY-SPONSORED RESEARCH AND DEVELOPMENT

This invention was made with government support from the U.S. Department of Energy under awards numbers DE-SC0001011, DE-FG02-06ER15788, and DE-FG26-08NT01925. The U.S. Government has certain rights in the invention.

### FIELD OF THE INVENTION

The present invention relates to harvesting light to do useful chemistry, in some embodiments. In other embodiments, the present invention relates to converting light into electrical current.

### BACKGROUND OF THE INVENTION

High surface area metal oxide electrodes coated with monolayers of chromophores are important to the operation of dye-sensitized solar cells (DSSCs) and dye-sensitized photoelectrosynthesis cells (DSPECs). In these devices, a small molecule dye known as a chromophore is bound to the surface of a semiconducting metal oxide electrode. In DSSCs, the chromophore absorbs a photon of light, and injects an electron into the metal oxide electrode also known as a photoanode. The electron enters the external circuit where it powers a device or charges a battery. The oxidized chromophore is reduced by an electron shuttle such as iodide (I⁻), which is oxidized to triiodide (I₃⁻). The circuit is then closed by electrons reducing triiodide (I₃⁻) back to iodide (I⁻) at the cathode. Inventive DSSCs and components thereof are described below.

Similar to a DSSC, a chromophore in a DSPEC device absorbs a photon of light and injects an electron into a semiconductor photoanode. An oxidation catalyst reduces the oxidized chromophore back to its original state, and oxidizes a species in the electrolyte such as H₂O to oxygen (O₂) and protons (H⁺). Alternatively, the catalyst itself absorbs the photon and injects the electron. The electron that enters the external circuit is transferred to the cathode where it can be used by a reduction catalyst to reduce protons (H⁺), or CO₂, or other molecules. Protons generated at the photoanode diffuse through a proton exchange membrane (PEM) to contact a reduction catalyst at the cathode. Oxygen (O₂) can be collected at the photoanode, while hydrogen (H₂) is collected at the cathode, in this example. The present disclosure describes examples of inventive DSPECs and components thereof.

One aspect of the operation of these devices is the initial light absorption and electron injection into the semiconductor material. Unlike a planar surface semiconductor where monolayer coverage results in less than 1% of the incident light being absorbed, the use of a high surface area nanocrystalline film increases the amount of dye that can be deposited and the light absorption can be greatly enhanced (>99% for a 10 μm thick film). The discovery and implementation of high surface area nanocrystalline TiO₂ by O'Regan and Gratzel marked the birth of a new class of solar cells based on dye-sensitization strategy.

One difficulty in planar and high surface area DSSCs and DSPECs, however, is the stability of chromophores and catalysts on the metal oxide surface. The stabilization of metal oxide bound chromophores and catalysts is important for the lifetime and ultimately, the commercial viability of DSSCs and DSPECs. This is particularly true in water oxidation DSPECs where the surface bound chromophores are known to be unstable under aqueous conditions particularly at elevated pHs. Thus, one technical problem to be solved by some embodiments of the present invention is the stabilization of surface-bound chromophores and catalysts in aqueous conditions.

### SUMMARY OF THE INVENTION

Applicants have unexpectedly discovered methods to stabilize chromophores and catalysts on metal oxide surfaces, and electrodes, DSSCs, DSPECs, and other components and devices incorporating the stabilization techniques described herein.

Atomic layer deposition (ALD) of ultra-thin metal oxide passivation layers may be used to prevent corrosion in inorganic photoelectrochemical systems. Without wishing to be bound by theory, a possible reaction mechanism for the formation of Al₂O₃ on TiO₂ with AlMe₃ as the precursor is illustrated in FIG. 1. The initiating step is a reaction between the hydroxide terminated groups on the TiO₂ surface and vapor phase AlMe₃ producing Ti—O—AlMe₂ and methane. In a subsequent step, gas phase addition of water leads to hydrolysis of Ti—O—AlMe₂ to give hydroxyl terminated Ti—O—Al—(OH)₂. Repetition of the AlMe₃-H₂O cycle results in layer-by-layer growth of amorphous Al₂O₃ at a rate of approximately 1.1 Å per cycle. ALD is self-limiting, uniformly coats porous surfaces, has sub-nanometer thickness control, and can be performed at low temperatures.

ALD of Al₂O₃ and other insulating oxides on the photoanodes of DSSCs may slow recombination between electrons in the semiconductor and the redox mediator or electron shuttle which increases open circuit voltage (V_{oc}) and improves device efficiency. ALD on semiconductor oxide scaffolds, either before or after chromophore functionalization, may also affect chromophore binding.

Some embodiments of the present invention provide an assembly comprising: a metal oxide surface; at least one first molecule attached to the metal oxide surface through one or more surface-linking groups, at least one second molecule attached to the surface wherein the second molecule is an oxide.

Other embodiments provide an electrode, for example that can be used in a DSSC or a DSPEC, comprising an assembly that comprises a metal oxide surface; at least one first molecule attached to the metal oxide surface through one or more surface-linking groups, at least one second molecule attached to the surface wherein the second molecule is an oxide.

Still other embodiments provide a dye-sensitized solar cell comprising an assembly that comprises a metal oxide surface; at least one first molecule attached to the metal oxide surface through one or more surface-linking groups, at least one second molecule attached to the surface wherein the second molecule is an oxide.

Additional embodiments relate to a dye-sensitized photoelectrosynthesis cell comprising an assembly comprising: a metal oxide surface; at least one first molecule attached to the metal oxide surface through one or more surface-linking groups, at least one second molecule attached to the surface wherein the second molecule is an oxide.

In some instances of the present invention, an assembly comprises a metal oxide surface comprising TiO₂; at least one [Ru(bpy)₂(4,4′-(PO₃H₂)₂bpy)]²⁺ linked to the metal oxide surface, and at least one Al₂O₃ linked to the surface. As used herein, bpy indicates the ligand 2,2′-bipyridine.

Applicants also have developed methods of making an assembly for harvesting light, comprising: providing a surface comprising a metal oxide; attaching at least one first molecule, which comprises at least one surface-linking group and at least one chromophore, to the surface through the at least one surface-linking group; attaching at least one second molecule to the surface; wherein the at least one second molecule is a conductive, semiconductive, or insulating oxide.

Further embodiments relate to methods of making an assembly for harvesting light, comprising: providing a surface comprising TiO₂; attaching at least one [Ru(bpy)₂(4,4′-(PO₃H₂)₂bpy)]²⁺ to the surface; and attaching at least one Al₂O₃ to the surface.

Still other instances of the present invention relate to methods of making an assembly for stabilizing a chromophore on a surface, comprising: providing a surface comprising TiO₂; attaching at least one [Ru(bpy)₂(4,4′-(PO₃H₂)₂bpy)]²⁺ to the surface; and attaching at least one Al₂O₃ to the surface.

Further instances relate to methods of stabilizing a chromophore on a surface, comprising: providing a surface comprising a metal oxide; attaching at least one first molecule, which comprises at least one surface-linking group and at least one chromophore, to the surface through the at least one surface-linking group; and attaching at least one second molecule to the surface; wherein the at least one second molecule is a conductive, semiconductive, or insulating oxide.

Additional embodiments relate to methods of making an assembly for catalyzing a chemical reaction, comprising: providing a surface comprising a metal oxide; attaching at least one first molecule, which comprises at least one surface-linking group and at least one catalyst, to the surface through the at least one surface-linking group; and attaching at least one second molecule to the surface; wherein the at least one second molecule is a conductive, semiconductive, or insulating oxide.

Yet additional embodiments of the present invention relate to methods of stabilizing an assembly for catalyzing a chemical reaction, comprising: providing a surface comprising a metal oxide; attaching at least one first molecule, which comprises at least one surface-linking group and at least one catalyst, to the surface through the at least one surface-linking group; and attaching at least one second molecule to the surface; wherein the at least one second molecule is a conductive, semiconductive, or insulating oxide.

### BRIEF DESCRIPTION OF THE DRAWINGS

The figures are not necessarily to scale, and should not be construed as limiting. Some details may be exaggerated to aid comprehension.

FIG. 1. Possible Reaction Scheme for the Atomic Layer Deposition of Al₂O₃ on TiO₂—RuP.

FIG. 2. Desorption rate constant (k_{des}) for TiO₂—RuP in H₂O as a function of the number of AlMe₃-H₂O cycles. Inset: Absorbance at 285 nm for the external H₂O₂ solution after 16 hrs. of photolysis.

FIG. 3. Absorption-time traces, at 400 nm, for TiO₂—RuP with 0, 1, 2, 3, 5, and 10 cycles of AlMe₃-H₂O. Data were obtained in Ar-deaerated pH 3 solutions (0.001 M HClO₄+0.1 M LiClO₄). Arrow shows progress from 0 to 10 cycles. Inset: Plot of the logarithm of k_{bet} as a function of the number of Al₂O₃ ALD cycles.

FIG. 4. Absorption spectra of TiO₂—RuP before and after 1 and 10 cycles of AlMe₃-H₂O.

FIG. 5. ATR-IR absorption spectra of a) TiO₂ and b) TiO₂—RuP before and after 10 cycles of AlMe₃-H₂O. Large arrows indicate AlMe₃-H₂O and small arrows indicate RuP.

FIG. 6. CV (10 mV/s) of TiO₂—RuP with 0, 1, 2, 3, 5, and 10 cycles of AlMe₃-H₂O in pH 3 aqueous solutions (0.001 M HClO₄+0.1 M LiClO₄): TiO₂ working, Ag/AgCl reference and a platinum counter electrodes. Arrow shows progress with increasing cycles of AlMe₃-H₂O.

FIG. 7. Photodesorption of TiO₂—RuP with 0 (a), 1 (b), 2 (c), 3(d), 5(e), and 10 (f) cycles of AlMe₃-H₂O in H₂O under constant 455 nm irradiation (475 mW/cm²). (Arrows show progress from 0 hours (black) to 16 hours (grey) every 15 minutes).

FIG. 8. Photodesorption of TiO₂—RuP with 3 cycles of AlMe₃-H₂O at 50° C. (a) and 120° C. (b) in pH 5 aqueous solution (10 μM HClO₄). (Arrows show progress from 0 hours (black) to 16 hours (green) every 15 minutes).

FIG. 9. Absorption spectra of external solution after photolysis of TiO₂—RuP with 1-10 cycles of AlMe₃-H₂O in H₂O.

FIG. 10. Photodesorption of TiO₂—RuP with 3 cycles of AlMe₃-H₂O in a) H₂O, b) pH 5 (10 μM HClO₄), c) pH 7 (0.1 M Na₃PO₄ buffer), d) pH 8.5 (0.1 M Na₃PO₄ and 0.5 M NaClO₄ buffer) aqueous solution and e) 0.1 M LiClO₄ MeCN under constant 455 nm irradiation (475 mW/cm²). (Arrows show progress from 0 hours (black) to 16 hours (green) every 15 minutes).

FIG. 11. Photodesorption of TiO₂—RuP with 0 (a) and 3 cycles (b) of AlMe₃-H₂O prior to RuP loading from a methanol solution. (Arrows show progress from 0 hours (black) to 16 hours (green) every 15 minutes).

FIG. 12. Steady-state emission spectra for TiO₂—RuP with 0, 1, 2, 3, 5, and 10 cycles of AlMe₃-H₂O in pH 3 aqueous solutions (0.001 M HClO₄+0.1 M LiClO₄).

FIG. 13. Relative emission intensity (black, left axis) and injection yield (red circle, right axis) of TiO₂—RuP in pH 3 aqueous solutions (0.001 M HClO₄+0.1 M LiClO₄) with respect to the number of cycles of AlMe₃-H₂O in H₂O.

### DETAILED DESCRIPTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a compound, dose, time, temperature, and the like, is meant to encompass variations of 20%, 10%, 5%, 1%, 0.5%, or even 0.1% of the specified amount. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs.

As stated above, some embodiments of the present invention provide an assembly comprising: a metal oxide surface; at least one first molecule attached to the metal oxide surface through one or more surface-linking groups, at least one second molecule attached to the surface wherein the second molecule is an oxide. The components of the assembly can be any suitable components, and the selection thereof can be performed by one of ordinary skill in the art according to any suitable criteria.

The metal oxide surface can comprise any suitable metal oxide and combinations of two or more metal oxides. In some cases, the metal oxide is chosen from SnO₂, TiO₂, Nb₂O₅, SrTiO₃, Zn₂SnO₄, ZrO₂, NiO, Ta-doped TiO₂, Nb-doped TiO₂, fluorine-doped tin oxide, indium tin oxide, antimony-doped tin oxide and combinations thereof. And the metal oxides can be in any suitable form. For example, certain instances provide at least some of the metal oxide in the form of nanoparticles, nanocrystals, nanocolumns, nanotubes, nanosheets, nanowires, nanotips, nanoflowers, nanohorns, nano-onions, dendritic nanowires, or a combination of two or more thereof. The metal oxide surface can be made according to any suitable method. Single crystals, sol gel process, sintering of nanopowders, combinations thereof, and the like are known to the skilled artisan and may be employed.

The first molecule can be any suitable choice. Some embodiments provide at least one first molecule that is a chromophore or catalyst. Other embodiments provide that the at least one first molecule comprises at least one chromophore and at least one catalyst. In those embodiments, the chromophore and catalyst can be bound together, co-located on the surface, or a combination thereof. In certain cases, the at least one first molecule is chosen from ruthenium coordination complexes, osmium coordination complexes, copper coordination complexes, porphyrins, phythalocyanines, and organic dyes, and combinations thereof. Methods for making many suitable first molecules are known, and many are commercially available. Chromophores include any suitable species that harvest light to achieve an excited state. In certain instances, a chromophore absorbs light and injects an electron into the conduction band of the semiconductor. It then oxidizes a redox mediator also called an electron shuttle (in a DSSC) or a bound, unbound, or co-located catalyst (in a DSPEC) to return the chromophore to the ground state. A catalyst optionally absorbs light itself and reaches an excited state, wherein it optionally injects an electron into the conduction band. The oxidized catalyst oxidizes a species in the electrolyte such as H₂O to oxygen (O₂) and protons (H⁺).

Suitable ruthenium coordination complexes include, but are not limited to:

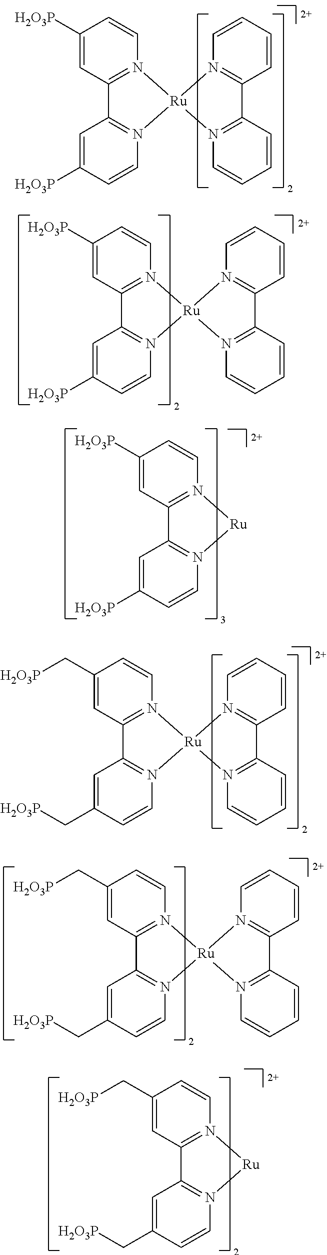

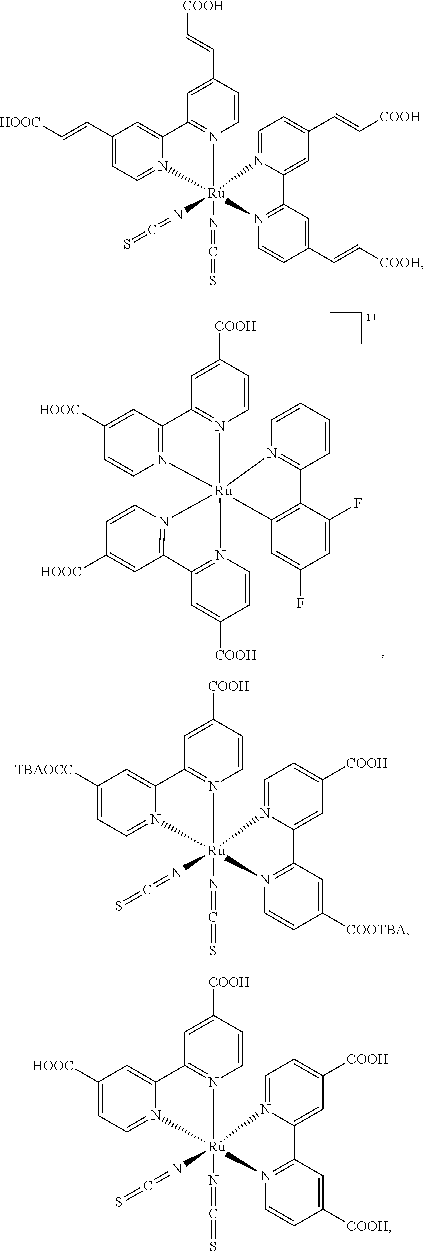

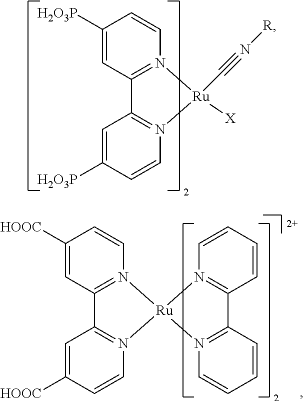

(X)₂bis(2,2′-bipyridyl-4,4′-dicarboxylate)ruthenium(II) compounds, wherein X is chosen from Cl, Br, I, CN, NC-Ph, and SCN;
deprotonated derivatives of any of the foregoing;
and combinations thereof.

Some embodiments of the present invention employ osmium coordination complexes chosen from:

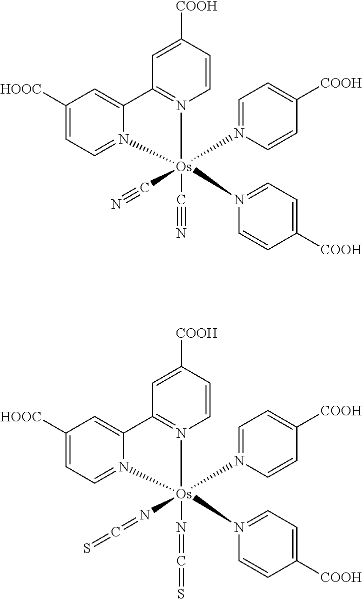

deprotonated derivatives thereof, and combinations thereof.

Other embodiments provide copper coordination complexes that are chosen from:

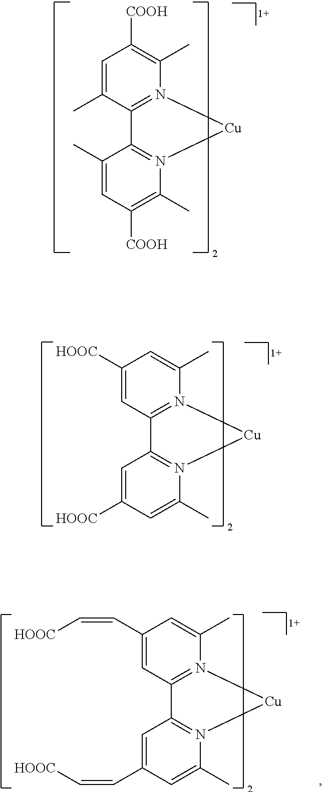

deprotonated derivatives thereof, and combinations thereof.

Still other embodiments employ porphyrins chosen from metal-coordination complexes comprising one of the following ligands:

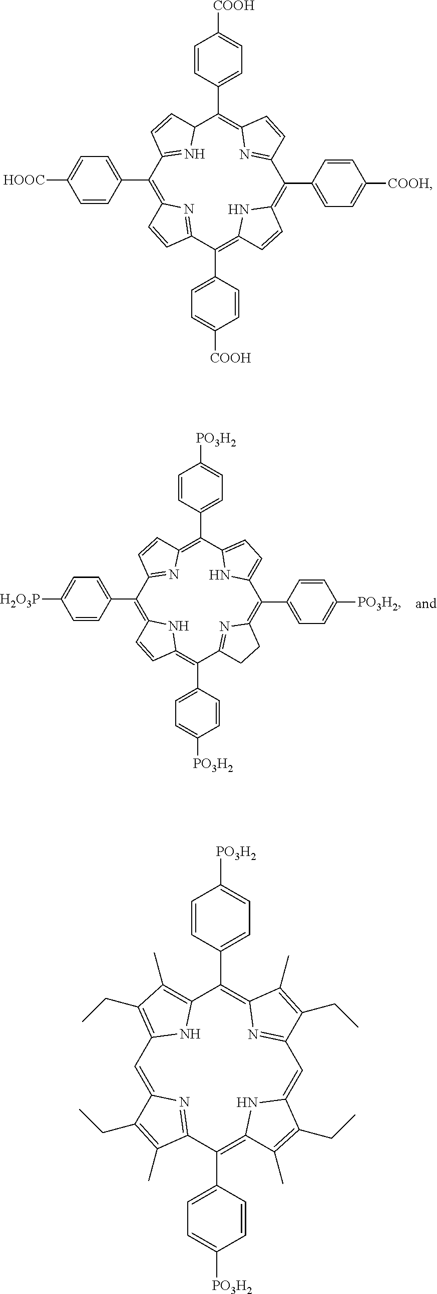

and deprotonated derivatives thereof. In some cases, the porphyrin is

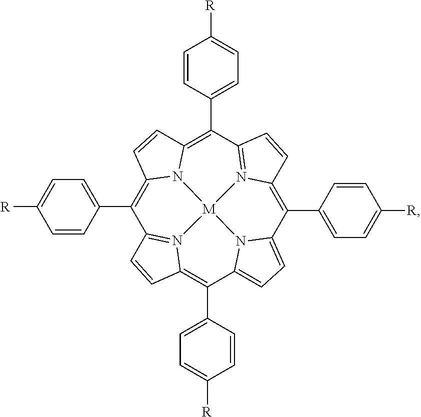

and M is Ni, Zn, Pd, Pb, Pt, or Ru, and R is chosen from —COOH, —PO₃H₂, or a deprotonated derivative thereof, or a combination of two or more of the foregoing. In some cases, the porphyrin is:

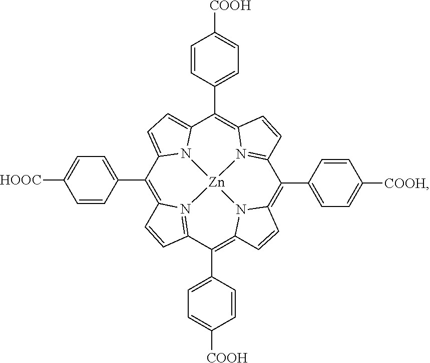

or a deprotonated derivative thereof.

Suitable phthalocyanines include, but are not limited to:

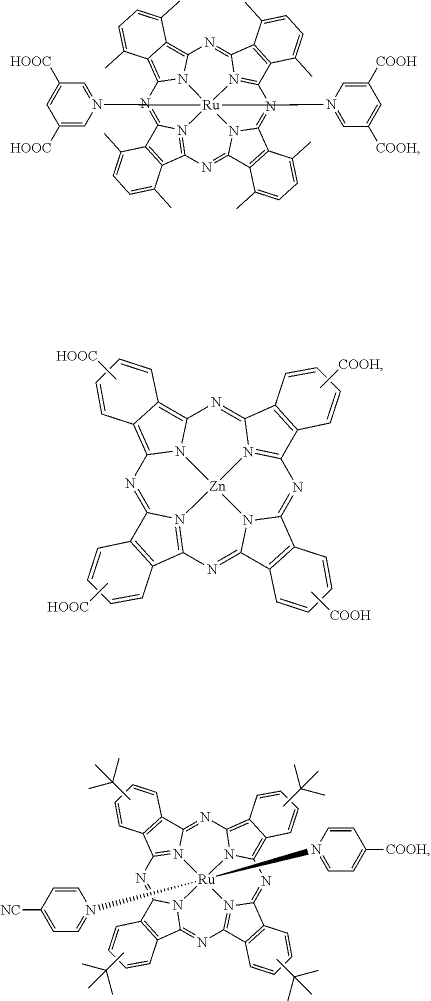

deprotonated derivatives thereof, and combinations thereof.

Organic dyes suitable for use in some embodiments of the present invention are chosen from:

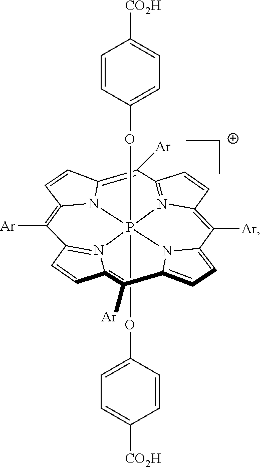

wherein Ar is 3,5-di-tertbutylphenyl;

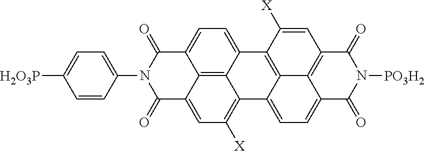

wherein X is halide, —CN, —CF₃, —CH₃, —Ph(CF₃)₂, Ph, Ph(CH₃)₂, or a combination thereof;
deprotonated derivatives thereof; and combinations thereof. As used herein, “Ph” relates to the phenyl group, C₆H₅—. Substituents can appear at any suitable position about the phenyl ring. When more than one substituent appears, they can be positioned in any suitable manner about the phenyl ring. In some cases, two substituents appear ortho, para to the carbon linking the phenyl ring to the rest of the molecule. In other cases, two substituents appear meta, meta to the linking carbon. In still other cases, two substituents appear in any suitable combination of ortho, meta, and/or para.

Catalysts useful in the present invention include any suitable catalysts. Suitable catalysts include, but are not limited to, single site water oxidation catalysts, multisite water oxidation catalysts, proton reduction catalysts, and combinations thereof. An example of a multisite water oxidation catalyst is the two-metal centered compound having the following structure:

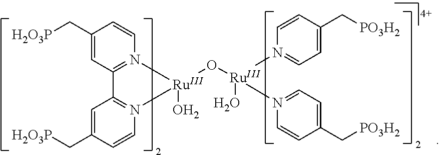

Deprotonated derivatives thereof also are contemplated. The foregoing compound can be synthesized analogously to the two-metal centered compound disclosed in S. W. Gersten, G. J. Samuels, and T. J. Meyer, J. Am. Chem. Soc. 1982, 104, 4029-4030. Phosphonation at the 4,4′ positions of the bpy ligands can be accomplished as reported in I. Gillaizeau-Gauthier, F. Odobel, M. Alebbi, R. Argazzi, E. Costa, C. A. Bignozzi, P. Qu and G. J. Meyer, Inorg. Chem., 2001, 40, 6073-6079. Some embodiments employ oxidation catalysts, which facilitate the oxidation of species in reactive communication with the catalyst. Other embodiments employ reduction catalysts, which facilitate the reduction of species in reactive communication with the catalyst. Catalysts suitable for use in certain embodiments of the present invention appear disclosed in U.S. Patent Application Publication No. US 2011/0042227 A1, to Corbea et al.

Suitable single site water oxidation catalysts, in some cases, comprise an atom of Ru, Co, Ir, Fe, or a combination thereof, when more than one such catalyst is present. In certain cases, the single site water oxidation catalyst is [Ru(2,6-bis(1-methylbenzimidazol-2-yl)pyridine)(4,4′-CH₂PO₃H₂-bpy)(OH₂)]²⁺ or a deprotonated derivative thereof.

When a chromophore and a catalyst are both present in an assembly, optionally they can be bound together in any suitable manner, such as, for example, by covalent bond. Synthetic methods to accomplish this are known or can be easily discerned. Thus, additional embodiments relate to assemblies comprising at least one chromophore and at least one catalyst.

Synthesis of many of the first molecules and second molecules are known, and some are commercially available. Chemical modification of molecules, or of precursors thereof, to add the surface linking groups, is also known or can be obtained by analogy to known modifications. Other first molecules and second molecules can be selected and synthesized in accordance with the guidance provided herein.

Surface linking groups can be chosen from any suitable surface linking groups. The surface linking groups employed in a given instance can be alike or different, and are independently chosen. In some cases, the surface linking group is chosen from —COON, —PO₃H₂, —SO₃H, —OPO₃H, —OSO₃H, —PH(OH)₂, —CH(CO₂H)₂, —CH═C(CO₂H)₂, —CONHOH, —CSSH, CSOH, and combinations thereof. Surface linking groups can interface with the assembly in any suitable manner. In some cases, the at least one second molecule is bonded to one or more surface linking groups. Synthetic chemistry methods for providing an assembly with one or more surface linking groups are known and can be chosen without undue experimentation.

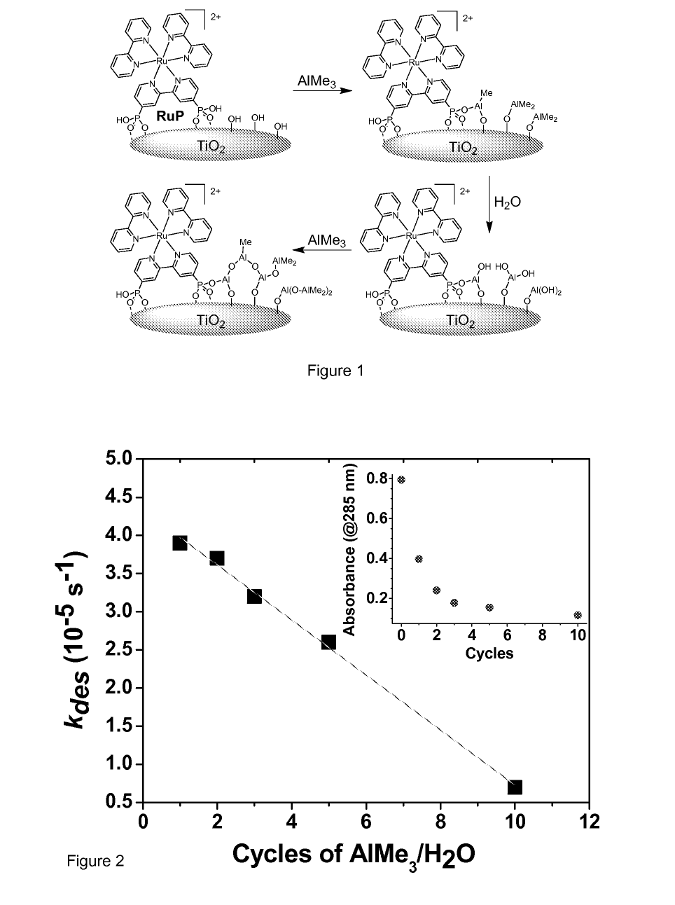

Deprotonated derivatives of suitable surface linking groups and first molecules disclosed herein are those in which one or more hydrogen ions have been removed to form the conjugate base. It is believed, although not necessary for the practice of the present invention, that the conjugate base of certain surface linking groups represent the form of the molecule actually appearing in certain embodiments of the present invention. That is to say, the deprotonated form links to surface sites on the metal oxide, in some cases. One, two, three, four, five, six, or any suitable number of protons can be removed to form a deprotonated derivative. For example, —PO₃H₂ can appear in some cases, while —PO₃H⁻ appears in other cases, while in still other cases, —PO₃²⁻ appears; combinations thereof are also possible. See FIG. 1. Methods for obtaining a deprotonated derivative are well known, such as, for example, by exposing the molecule to an increased pH, or by increasing the concentration of cations in solution.

The second molecule can be any suitable choice. Certain embodiments provide at least one second molecule that is an oxide. In some cases, the at least one second molecule is conducting; in other cases, the at least one second molecule is semiconducting; and in still other cases, the at least one second molecule is insulating. “Conducting,” “semiconducting,” and “insulating” refer to electrical conductivity, and the skilled artisan appreciates that those terms are relative. For example, a material with a large band gap (for example 3 eV) can be characterized as an insulator or a wide band-gap semiconductor. As used herein, a conducting material has an electrical band gap less than about 0.1 eV; an insulating material has an electrical band gap greater than about 4 eV. Semiconducting materials have electrical band gaps between those limits.

Certain instances provide that the at least one second molecule is chosen from: oxide dielectrics, oxide conductors, oxide semiconductors, ternary oxides, nitride dielectrics, nitride semiconductors, metallic nitrides, group II-VI semiconductors, group II-VI based phosphors, group II-V semiconductors, fluorides, CaF₂, SrF₂, MgF₂, LaF₃, and ZnF₂, elements, PbS, SnS, In₂S₃, Sb₂S₃, CuₓS, CuGaS₂, WS₂, SiC, Ge₂Sb₂Te₅, and combinations thereof. In the example CuₓS, x is any suitable integer, such as, for example, 1, 2. Other instances provide that the at least one second molecule is chosen from Al₂O₃, ZrO₂, and HfO₂ and combinations thereof. Since more than one second molecule can be present, in some embodiments, one or more of the at least one second molecule is bonded to another second molecule. Any suitable precursors for the second compound can be used. For example, ALD of metal compounds containing alkyl, alkoxy, amido, halide, and cyclopentadienyl substituents has been reported.

Some embodiments of the present invention provide a measurable increase in the stability of a chromophore or catalyst on a metal oxide surface. In certain cases, the desorption rate constant of the at least one first molecule measured in water (k_{des}) is equal to or less than about 3.9×10⁻⁵ s⁻¹. In other cases, the desorption rate constant of the at least one first molecule measured at pH 8.5 (k_{des}) is equal to or less than about 10.9×10⁻⁵s⁻¹. Desorption rate constants can be measured by any suitable means, such as, for example, by the method illustrated in the Examples.

Other embodiments provide measurable performance characteristics of the light-harvesting assembly. In certain instances of the present invention, the cross surface electron diffusion coefficient (Dₐₚₚ) is equal to or less than about 1.32×10⁻¹⁰ cm²/s. In other instances, the electron ejection efficiency (φᵢₙⱼ) is equal to or greater than about 47%. In still other instances, the back electron transfer rate (k_{bet}) is equal to or less than about 4.8×10⁴s⁻¹. In yet additional instances, the electron ejection efficiency (φᵢₙⱼ) is equal to or greater than about 47% and the back electron transfer rate (k_{bet}) is equal to or less than about 4.8×10⁴ s⁻¹. Those performance characteristics can be measured by any suitable means, such as, for example, by the methods illustrated in the Examples.

Some embodiments provide an electrode. Such an electrode can comprise at least one assembly for harvesting light, in certain embodiments. Electrodes can comprise any suitable substrate for the assembly. In some cases, a substrate comprises a metal, such as, for example, copper, nickel, gold, silver, platinum, steel, glassy carbon, silicon, and alloys comprising one or more thereof. In other cases, the substrate is transparent or semitransparent to allow light to pass through the substrate to allow the assembly to harvest such light. Fluorine-doped tin oxide coated on glass, or indium-doped tin oxide on glass can be used in such cases. Electrodes in the present invention include any suitable materials. When an electrode comprises a glass substrate and a transparent conducting metal oxide coating, such as, for example, fluorine-doped tin oxide or indium tin oxide, a high surface area metal oxide surface is constructed on the transparent conducting metal oxide coating, in some embodiments. That high surface area metal oxide surface forms part of the assembly in certain cases.

Assemblies of the present invention can be incorporated into dye-sensitized solar cells or dye-sensitized photoelectrosynthesis cells, as the skilled artisan wishes. Suitable electrolytes, counter electrodes, optionally reference electrodes, external circuitry, and the like can be chosen by the skilled artisan. Some cases provide a metal oxide surface, such as a high surface area TiO₂, and a first molecule is attached to the surface in any suitable manner. In one instance, the TiO₂ is exposed to a composition containing the first molecule, and the first molecule comprises a surface linking group that reacts with the TiO₂, thereby attaching the first molecule to the surface. Then, a second molecule is attached in any suitable manner, such as by ALD. The first molecule can be [Ru(bpy)₂(4,4′-(PO₃H₂)₂bpy)]²⁺ in some instances, and the linking group shown in that first molecule is —PO₃H₂. In other instances, the second molecule is Al₂O₃.

### INDUSTRIAL APPLICABILITY

The various embodiments of the present invention are susceptible to industrial exploitation in the realms of energy production, energy storage, and chemical synthesis. For example, light can be converted into electrical current, in some embodiments. In other embodiments, energy can be stored in the form of oxygen on the one hand, and hydrogen, methane, other hydrocarbon, or other fuel on the other hand. Useful chemicals can be synthesized by the photocatalytic effect available to certain embodiments. Other aspects of industrial applicability can be discerned by reference to the specification and claims.

The present invention will now be described in more detail with reference to the following examples. However, those examples are given for the purpose of illustration and are not to be construed as limiting the scope of the invention.

### EXAMPLES

We report here the ALD of Al₂O₃ on [Ru(bpy)₂(4,4′-(PO₃H₂)₂bpy)]²⁺ (RuP in FIG. 1) functionalized nanocrystalline TiO₂ (TiO₂—RuP) and its effects on photostability and electron transfer rates in the films.

### Sample Preparation.

Materials. Aqueous solutions were prepared from MilliQ purified water. Titanium isopropoxide, 70% perchloric acid (99.999% purity), and Carbowax 20M were used as received from Sigma-Aldrich. Fluorine-doped tin oxide (FTO) coated glass (Hartford Glass Co.; sheet resistance 15 Ω cm⁻²), was cut into 11 mm×50 mm strips and used as the substrate for TiO₂ nanoparticle films. RuP was prepared according to previously published procedures.

Dye-Sensitized Nanocrystalline TiO₂ Thin Films. Nanocrystalline TiO₂ (nano-TiO₂) films, 7.0 μm thick, coating an area of 11 mm×25 mm on top of FTO glass were prepared according to previously published procedures. Monolayer films were loaded overnight from solutions of 150 μM RuP in methanol for the post ALD loaded films and control sample or in aqueous 0.1 M HClO₄ for all other samples. The films were then rinsed with methanol and dried under a stream of nitrogen.

Atomic Layer Deposition. Atomic layer deposition (ALD) was conducted in a home-built, hot walled, flow tube reactor. The main reaction chamber is a 24-inch long, 1.35-inch inner diameter stainless steel nipple with Conflat® connections. The reaction zone is heated with resistive heaters and monitored by three thermocouples affixed to the reactor tube. Precursors are delivered into the reaction zone through ¼-inch stainless steel tubing, heated to 70° C. in order to preheat the process gas and to prevent precursor condensation in the gas lines. Nitrogen carrier gas flow (99.999% purity, National Welders) is metered with a needle valve and exhausted from the reactor with an Alcatel Pascal 2010SD rotary vane pump. Pressure is monitored after the reaction zone with a Convectron gauge. Precursor gases are pulsed into the reactor using three-way fast actuating diaphragm valves controlled electronically by a LabVIEW sequencer. For aluminum oxide (Al₂O₃) deposition we used 98% trimethyl aluminum (TMA) (Strem Chemicals) and reagent grade water (Ricca Chemicals) as precursors. Standard Al₂O₃ ALD coatings were conducted at 115° C. and 0.5 Torr of N₂ carrier gas with a sequence of 0.3 s TMA dose, 60 s hold, 180 s N₂ purge, 0.3 s H₂O dose, 60 s hold, 180 s N₂ purge, where a hold involves closing of all precursor and gate valves.

Electrochemical and Photophysical Characterization.

Absorption spectroscopy. The UV-visible spectra were recorded using an Agilent 8453 UV-Visible photo diode array spectrophotometer (for spectral changes), a Varian Cary 5000 UV-Vis-NIR spectrophotometer (spectroelectrochemistry) or a Varian Cary 50 UV-Vis spectrophotometer (photostability).

Transient absorption (TA) measurements were carried out by inserting derivatized thin films at a 45° angle into a standard 10 mm path length square cuvette containing pH 3 aqueous solutions (0.001 M HClO₄) with 0.1 M LiClO₄. The top of the cuvette was fit with an o-ring seal with a Kontes valve inlet to allow the contents to be purged with Argon. TA experiments were performed by using nanosecond laser pulses produced by a Spectra-Physics Quanta-Ray Lab-170 Nd:YAG laser combined with a VersaScan OPO (532 nm, 5-7 ns, operated at 1 Hz, beam diameter 0.5 cm, ˜5 mJ/pulse) integrated into a commercially available Edinburgh LP920 laser flash photolysis spectrometer system. White light probe pulses generated by a pulsed 450 W Xe lamp were passed through the sample, focused into the spectrometer (3 nm bandwidth), then detected by a photomultiplier tube (Hamamatsu R928). Appropriate color filters were placed before the detector to reject unwanted scattered light. Detector outputs were processed using a Tektronix TDS3032C Digital Phosphor Oscilloscope interfaced to a PC running Edinburgh's L900 (version 7.0) software package. Single wavelength kinetic data were the result of averaging 50 laser shots and were fit using either Origin or Edinburgh software. The data were fit over the first 10 μs by using the tri-exponential function in equation S1 and the weighted average lifetime (<τ>) calculated from equation S2. The results of multiple measurements revealed variations in the kinetic fit parameters of <5% with general trends reproduced in three separate trials.

A=A₁e^{-k1t}+A₂e^{-k2t}+A₃−k3t (eq S1)

τᵢ=1/kᵢ; <τ>=ΣAᵢτᵢ²/ΣAᵢτ (eq S2)

Electron injection efficiencies (Φᵢₙⱼ) were calculated using the absorption (at 532 nm) corrected ΔOD of the samples relative to TiO₂—RuP in pH 3 HClO₄ which has a known injection efficiency of 85%. The molar extinction coefficient difference between ground and excited/oxidized states of TiO₂—RuP with 0, 1, 2, 3, 5, and 10 cycles of ALD was assumed to be the same as the film without treatment. The only minor spectral shifts in absorption after ALD suggest that this is a reasonable is assumption.

Steady-State Emission data were collected at room temperature using an Edinburgh FLS920 spectrometer with luminescence first passing through a 495 nm long-pass color filter, then a single grating (1800 l/mm, 500 nm blaze) Czerny-Turner monochromator (5 nm bandwidth) and finally detected by a peltier-cooled Hamamatsu R2658P photomultiplier tube. The samples were excited using light output from a housed 450 W Xe lamp/single grating (1800 l/mm, 250 nm blaze) Czerny-Turner monochromator combination with 5 nm bandwidth.

Photo-Stability measurements were performed by use of a previously reported procedure. The light from a Royal Blue (455 nm, FWHM ˜30 nm, 475 mW/cm²) Mounted High Power LED (Thorlabs, Inc., M455L2) powered by a T-Cube LED Driver (Thorlabs, Inc., LEDD1 B) was focused to a 2.5 mm diameter spot size by a focusing beam probe (Newport Corp. 77646) outfitted with a second lens (Newport, Corp 41230). Light output was directed onto the derivatized thin films placed at 45° in a standard 10 mm path length cuvette containing 5 mL of the solutions of interest. The illumination spot was adjusted to coincide both with the thin films and the perpendicular beam path of a Varian Cary 50 UV-Vis spectrophotometer. The absorption spectrum (360-800 nm) of the film was obtained every 15 minutes during 16 hours of illumination. The incident light intensity was measured using a thermopile detector (Newport Corp 1918-C meter and 818P-020-12 detector). The solution temperature, 22±2° C., was consistent throughout the duration of the experiment.

The absorption-time traces at 480 nm could be satisfactorily fit with the biexponential function in equation S3. For comparative purposes, the results of the multi-exponential analysis were represented by a single rate constant, the disappearance or desorption rate constant, k_{des}, by calculating the weighted average lifetime (<τ>) by application of equation S4. In equation S4, Aᵢ and τᵢ are the contributions to the absorbance amplitude and lifetime of component i.

y=A₁e^{-x/τ}^{₁}+A₂e^{-x/τ}^{₂}+₀ (eq S3)

1/k_{des}=<τ>=ΣAᵢτᵢ²/ΣAᵢτᵢ (eq S4)

Electrochemical Measurements. Cyclic voltammetry (CV) measurements were performed by using a CH Instruments Model 600D Series Electrochemical Workstation with TiO₂—RuP as the working electrode, a platinum wire counter electrode and a Ag/AgCl or saturated calomel electrode (SCE) reference electrode (BASi). All measurements were performed in pH 3 aqueous solutions (0.001 M HClO₄) with 0.1 M LiClO₄. CV traces were collected at a scan rate of 10 mV/s. The potential of the reference electrode was adjusted by 0.24 V for the reported potentials versus NHE.

Cross-surface electron transfer measurements were performed by monitoring changes in absorption at 490 nm using a Cary 5000 UV-Vis spectrophotometer during the application of 1.5 V for 10 minutes followed by 0 V for 10 minutes. The early time (<1.5 min) absorption (A)-time (t) data as plots of A vs. t^{1/2} were analyzed by a modified version of the Cottrell equation (equation S5) to give the apparent charge-transfer diffusion coefficients (Dₐₚₚ). In equation S5, ΔA is the change in absorbance at time t, Aₘₐₓ is the absorbance at t=0 and d is the film thickness (7 μm).

ΔA=(2AₘₐₓDₐₚₚ^{1/2}t^{1/2})/(dπ^{1/2}) (eq S5)

Attenuated Total Reflectance Infrared Spectra were recorded using a Bruker Alpha FTIR spectrometer (SiC Glowbar source, DTGS detector) with a Platinum ATR quickSnap sampling module (single reflection diamond crystal). Spectra were acquired from 800 to 1800 cm⁻¹ at a resolution of 4 cm⁻¹. All ATR-IR spectra are reported in absorbance with a blank versus atmosphere.

### Results.

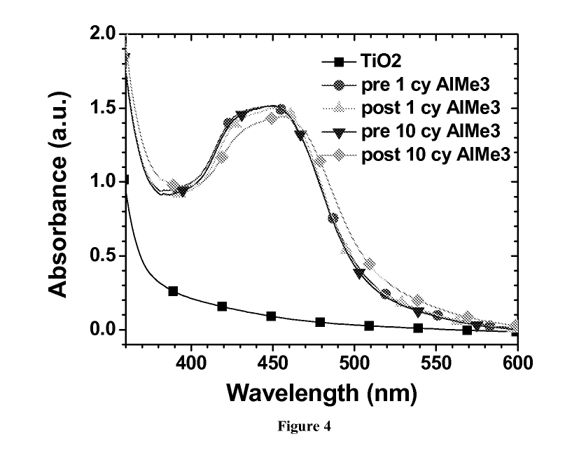

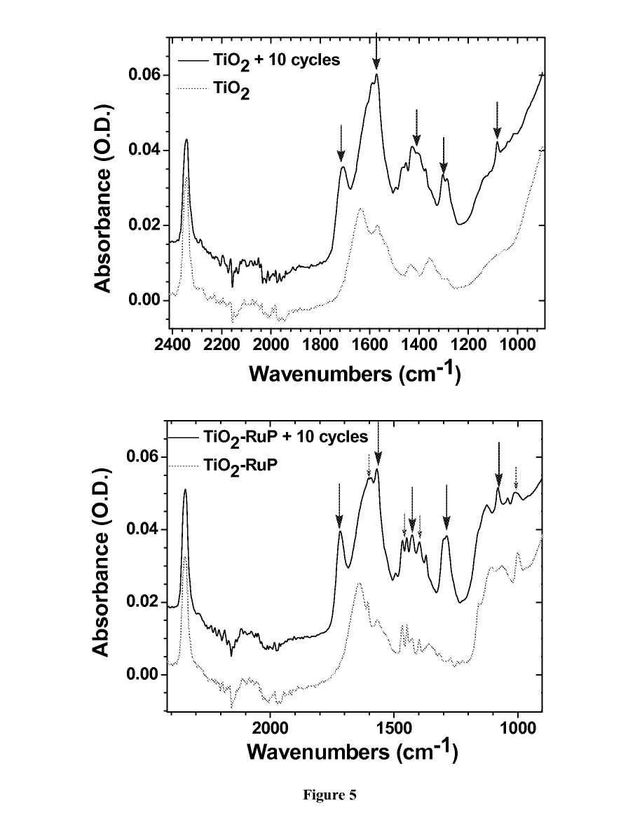

Atomic Layer Deposition (ALD) of 1, 2, 3, 5 and 10 cycles of AlMe₃—H₂O at 115° C. and 0.5 Torr was conducted on TiO₂—RuP substrates. The intensity of the ground state metal-to-ligand charge transfer (MLCT) band of TiO₂—RuP remained unchanged after ALD indicating that RuP is not lost during the treatment, although there was a noticeable red shift in the spectrum after 10 ALD cycles (FIG. 4).

Attenuated total reflectance infrared spectra of TiO₂—RuP after ALD includes characteristic bands for both TiO₂—RuP and AlMe₃-H₂O deposited Al₂O₃ (FIG. 5). ALD has a minimal effect on the electrochemical properties of the chromophore with the Ru^{3+/2+} couple of RuP, appearing at E_{1/2} ˜1.1 V vs Ag/AgCl, unchanged from the original surface (Table 1).

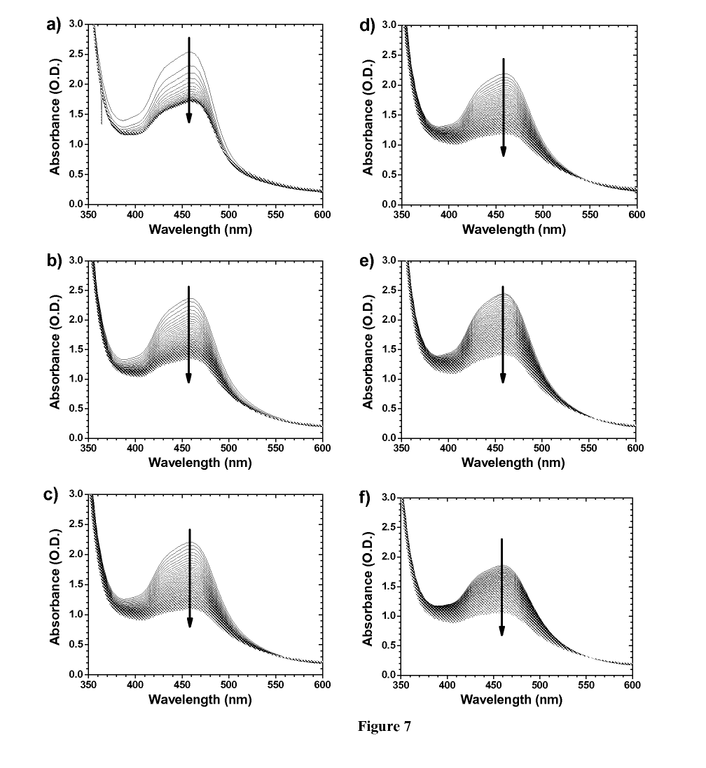

Photostabilities of the TiO₂—RuP films were evaluated by using a previously published procedure with constant irradiation at 455 nm (FWHM ˜30 nm, 475 mW/cm²). See FIG. 7. The time-dependent changes in absorption, due to chromophore desorption, are presented as a single average rate constant (k_{des}) calculated as the inverse of the weighted average lifetime (k_{des}=<τ>⁻¹) from analysis of the absorption-time traces at 480 nm (Table 1).

The desorption rate constant for TiO₂—RuP in water after even one cycle of AlMe₃—H₂O treatment (3.9×10⁻⁵ S⁻¹) is significantly lower than the untreated film (>30×10⁻⁵ s⁻¹). The stabilizing effect of Al₂O₃ is linear from 1 to 10 ALD cycles, with the desorption rate constant of the latter being 5 times slower than the former (FIG. 2 and Table 1).

TABLE 1
Equilibrium and Dynamic Surface Parameters for TiO₂—RuP
after 0, 1, 2, 3, 5 and 10 Cycles of AlMe₃—H₂O. Data Were
Obtained in pH 3 Aqueous Solution (0.001M HClO₄ + 0.1M
LiClO₄) Unless Otherwise Noted.

| | | E_{1/2} | Dₐₚₚ | | k_{bet} |
|---|---|---|---|---|---|
| Cycles of | k_{des} | (Ru^{III/II}) | (×10⁻¹⁰ | | (×10⁴ |
| AlMe₃—H₂O | (×10⁻⁵ s⁻¹)^{a} | (V)^{b} | cm²/s) | Φᵢₙⱼ | s⁻¹) |
| 0 | >30 | 1.10 | 4.05 | 85 | 6.3 |
| 1 | 3.9 | 1.10 | 1.26 | 83 | 5.3 |
| 2 | 3.7 | 1.10 | 1.32 | 67 | 5.1 |
| 3 | 3.2 | 1.12 | 1.02 | 64 | 4.8 |
| 5 | 2.6 | 1.12 | 0.43 | 47 | 3.9 |
| 10 | 0.7 | 1.12 | 0.10 | 17 | 3.3 |

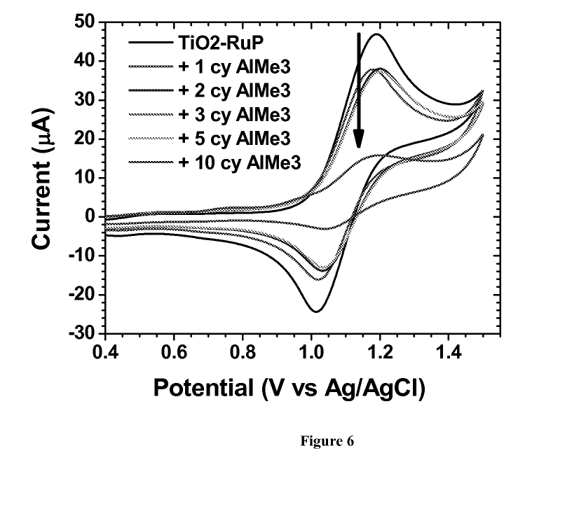

^{a}In H₂O.
^{b}From CV measurements on TiO₂ vs. Ag/AgCl reference electrode (0.197 V vs NHE) (FIG. 6).

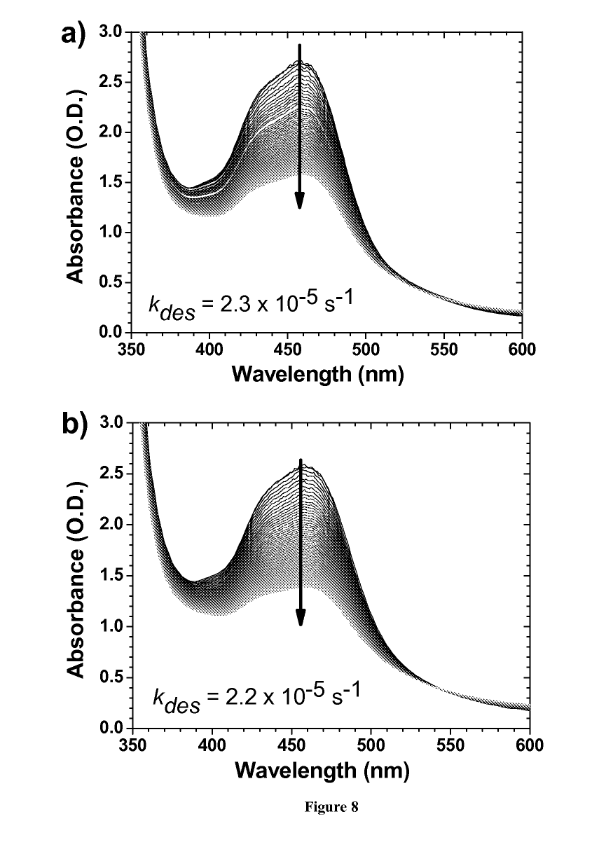

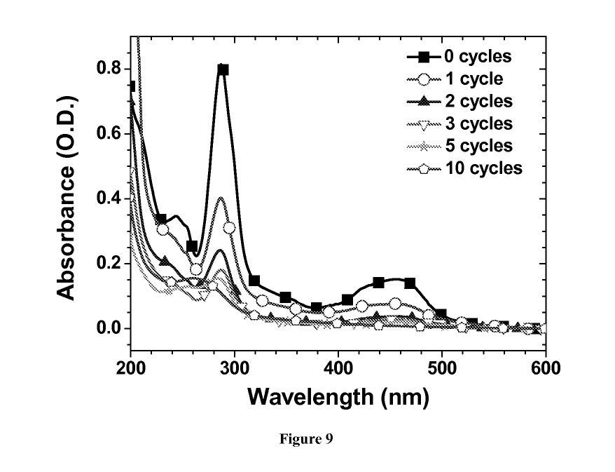

Variations in temperature (50° C. vs 120° C.) during the deposition of three ALD cycles had a negligible effect on the desorption rate constant (FIG. 8). The intensity of the π-π* absorption band of RuP (285 nm) of the external H₂O solution after photolysis (FIG. 9) is an indicator of the total chromophore desorption from TiO₂. Due to the low concentration of chromophore, complete desorption of RuP from only the spot of irradiation results in a solution absorbance of <0.2 at 285 nm. For samples with 0, 1, and 2 ALD cycles there is significant absorbance (>0.2) in the external solution, inset of FIG. 2, suggesting that there is thermal and/or photodesorption from the entire slide and not just from the site of irradiation. This desorption mechanism is inhibited for TiO₂—RuP after 3 or more ALD cycles.

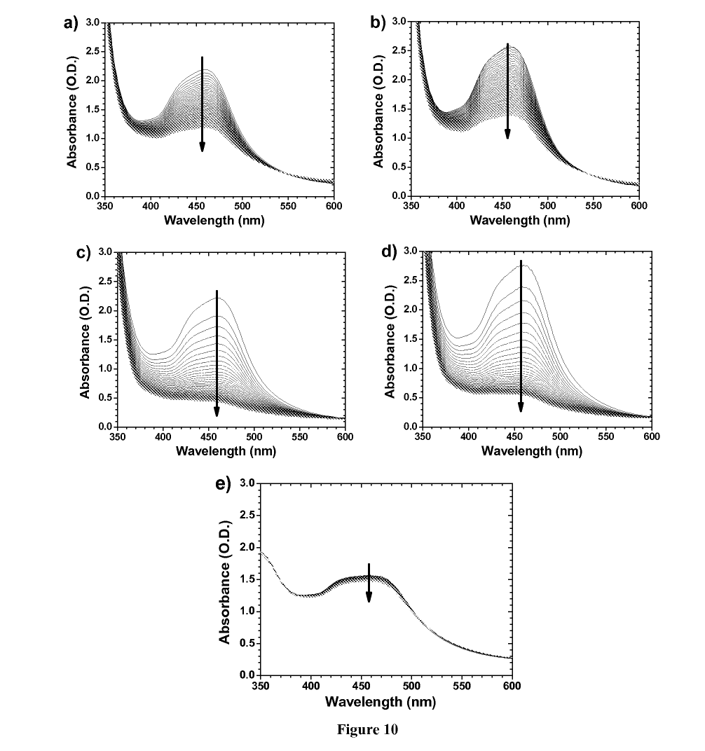

The photostability of TiO₂—RuP after three AlMe₃—H₂O cycles was measured under various conditions (FIG. 10) and the results are summarized in Table 2. In previous experiments, photo-stability of TiO₂—RuP under aqueous conditions was maximized at pH=1 (0.1 M HClO₄) with desorption rate constants increasing at higher pHs. It is notable that at pH 5 and in H₂O the desorption rate constant, 2.3 and 3.2×10⁻⁵ s⁻¹ respectively, for the ALD treated film is lower than for the untreated slides in pH 1 aqueous solution (pH 1=5.0×10⁻⁵ s⁻¹). Even in solutions buffered at pH 7 and 8.5, the ALD treated slides have desorption rate constants only twice as rapid as for TiO₂—RuP in 0.1 M HClO₄. This is a significant improvement over untreated TiO₂—RuP where fast desorption from the entire slide allows for only lower estimates for the desorption rate constant (>20×10⁻⁵ s⁻¹ at pH 5). Desorption from untreated films was too rapid (<30 minutes) in pH 7 and 8.5 buffered solution to quantify by using our standard protocol.

TABLE 2
Summary of desorption rate constants (k_{des}) for TiO₂—RuP with
and without three cycles of AlMe₃—H₂O, in various solvents.

k_{des} (×10⁻⁵ s⁻¹)

| Solvent | +3 cycles | +0 cycles |
|---|---|---|
| pH 1^{a} | — | 5.0 |
| pH 5^{b} | 2.3 | >20 |
| H₂O | 3.2 | >30 |
| pH 7^{c} | 9.5 | — |
| pH 8.5^{d} | 10.9 | — |
| MeCN^{e} | <0.01 | 0.8 |

^{a}0.1M HClO₄,
^{b}10 μM HClO₄,
^{c}0.1M Na₃PO₄ buffer,
^{d}0.1M Na₃PO₄ and 0.5M NaClO₄ buffer,
^{e}0.1M LiClO₄.

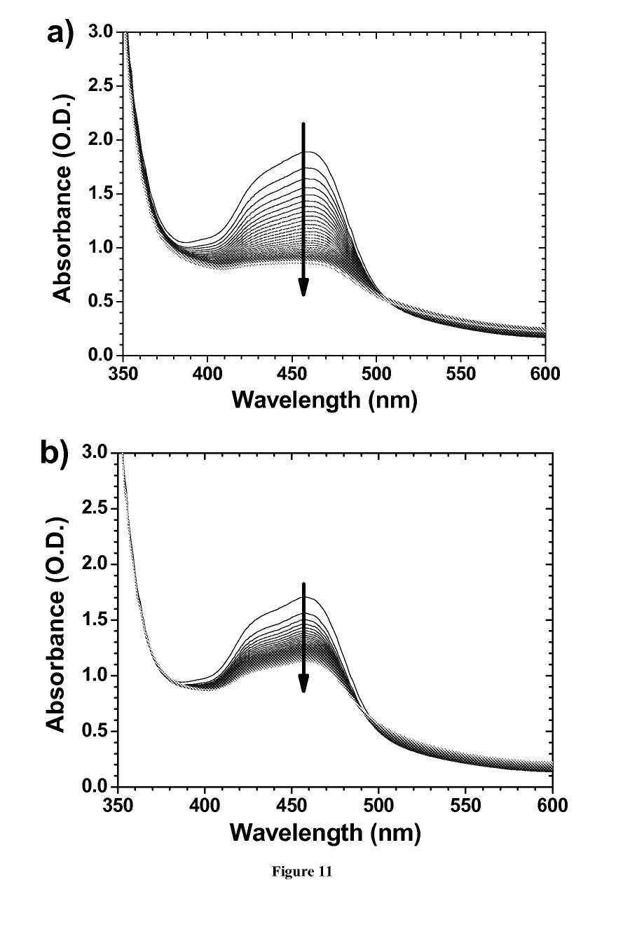

Attachment of RuP to nanocrystalline TiO₂ pre-coated with three ALD cycles of Al₂O₃ did not drastically decrease the photochemical desorption rate (FIG. 11) and still resulted in significant desorption from the entire slide. This result suggests that the stabilizing effect is not simply due to enhanced bonding of phosphonates to Al₂O₃ relative to TiO₂.

Al₂O₃ is expected to deposit in the gaps between chromophores where OH groups on the TiO₂ surface are exposed (FIG. 1). A dynamic element associated with buildup of Al₂O₃ between chromophores is the order of magnitude decrease in cross surface electron diffusion coefficient (Dₐₚₚ) with increased ALD cycles (Table 1), as measured by chronoabsorptometry. Since the surface loading and reduction potential for the RuP^{3+/2+} couple are unchanged, the reduction in Dₐₚₚ may arise from decreased electronic coupling between adjacent chromophores because of an intervening rigid layer of “insulating” Al₂O₃.

The growth of Al₂O₃ in the inter-chromophore space between complexes presumably inhibits the diffusion of H₂O and OH⁻ to the underlying surface binding groups, which hinders hydrolysis and desorption, effectively stabilizing the surface.

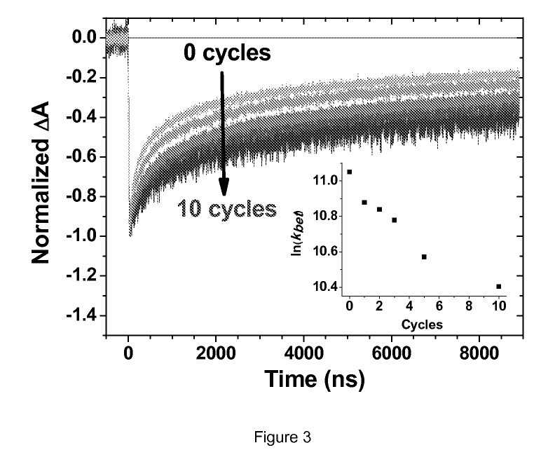

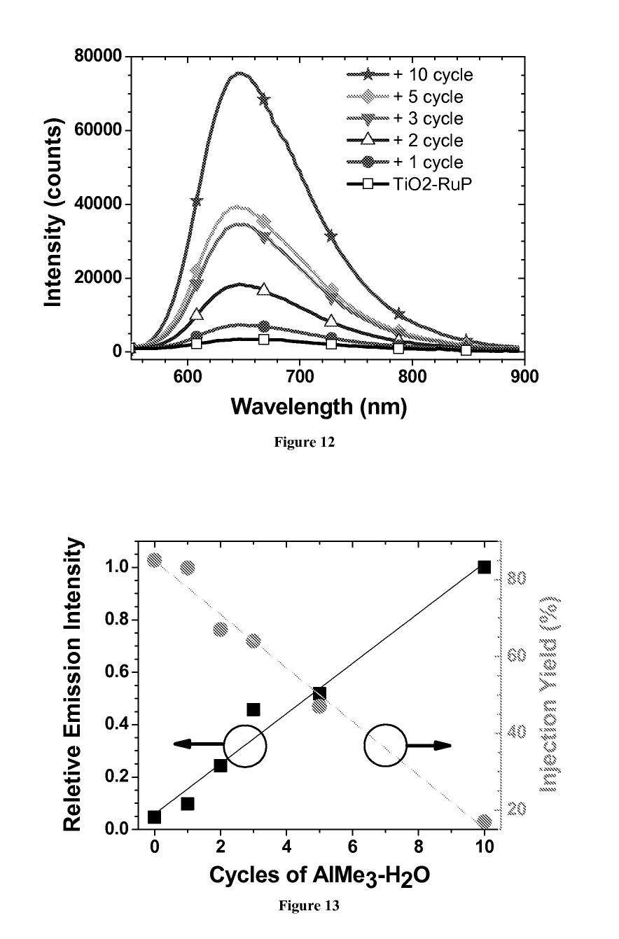

Deposition of Al₂O₃ also has an effect on interfacial electron transfer dynamics following excitation of TiO₂—RuP. There is an approximately linear increase in emission intensity (FIG. 12, FIG. 13) and a corresponding decrease in electron injection efficiency as the number of AlMe₃—H₂O cycles is increased (FIG. 13). Similarly, the back electron transfer rate constant (k_{bet}) decreases exponentially with increasing cycles of ALD (Table 1 and the inset in FIG. 3).

Similar, albeit more pronounced, decreases in electron transfer rate constants and injection efficiencies have been reported on nanocrystalline TiO₂ coated with increasing thicknesses of Al₂O₃ which were then functionalized with the DSSC dyes N3 and N719. The resulting effect on dynamic behavior was attributed to either an increase in the conduction band potential of TiO₂ with Al₂O₃ deposition and/or a reduction in the extent of electronic coupling between the chromophore and TiO₂.

Without wishing to be bound by theory, the origin of the decreased injection yields and enhanced emission in our results may be due to the ALD of Al₂O₃ altering the conduction band potential of TiO₂. However, at least partial deposition of Al₂O₃ under the chromophore may occur resulting in an increased separation distance between TiO₂ and RuP during the ALD process.

TABLE 3
Injection yields, back electron transfer lifetimes, and k_{bet}
from transient absorption measurements of TiO₂-RuP with
0, 1, 2, 3, 5, and 10 cycles of AlMe₃—H₂O
in pH 3 aqueous solutions (0.001M HClO₄ + 0.1M LiClO₄).

| | | Lifetime (ms) | | | | |
|---|---|---|---|---|---|---|
| | | | | | | k_{bet} |
| complex | Φᵢₙⱼ | t₁ (A₁) | t₂ (A₂) | t₃ (A₃) | <t> | (10⁴S⁻¹) |
| TiO₂-RuP | 85 | 0.17(1) | 1.18(6) | 15.9(93) | 15.8 | 6.3 |
| +1 cycle | 83 | 0.20(1) | 1.41(5) | 19.0(94) | 18.9 | 5.3 |
| +2 cycles | 67 | 0.18(1) | 1.25(4) | 19.5(95) | 19.4 | 5.1 |
| +3 cycles | 64 | 0.22(1) | 1.40(4) | 21.0(95) | 20.9 | 4.8 |
| +5 cycles | 47 | 0.26(1) | 1.73(3) | 25.4(96) | 25.3 | 3.9 |
| +10 cycles | 17 | 0.31(1) | 1.90(3) | 30.0(96) | 29.9 | 3.3 |

In summary, ALD of Al₂O₃ on a chromophore derivatized nanocrystalline TiO₂ surface has been demonstrated as a viable technique for significantly increasing the stability of the film in aqueous conditions. Increasing ALD cycles increases stability and decreases back electron transfer rates, which are desirable but at the cost of decreased injection yields, which is undesirable. For Al₂O₃ on TiO₂ a balance between these effects will be necessary to optimize device performance.

### REFERENCES

(1) Hagfeldt, A.; Boschloo, G.; Sun, L.; Kloo, L.; Pettersson, H. Chem. Rev. 2010, 110, 6595.
(2) Hanson, K.; Brennaman, M. K.; Luo, H.; Glasson, C. R. K.; Concepcion, J. J. Song, W.; Meyer, T. J. ACS Appl. Mater. Interfaces 2012, 4, 1462.
(3) Hanson, K.; Brennaman, M. K.; Ito, A.; Luo, H.; Song, W.; Parker, K. A.; Ghosh, R.; Norris, M. R.; Glasson, C. R. K.; Concepcion, J. J.; Lopez, R.; Meyer, T. J. J. Phys. Chem. C 2012, 116, 14837.
(4) Peng, Q.; Lewis, J. S.; Hoertz, P. G.; Glass, J. T.; Parsons, G. N. Journal of Vacuum Science & Technology A: Vacuum, Surfaces, and Films 2012, 30, 010803.
(5) Jur, J. S.; Parsons, G. N. ACS Applied Materials & Interfaces 2011, 3, 299.
(6) Parsons, G. N.; George, S. M.; Knez, M. MRS Bulletin 2011, 36, 865.
(7) Lin, C.; Tsai, F.-Y.; Lee, M.-H.; Lee, C.-H.; Tien, T.-C.; Wang, L.-P.; Tsai, S.-Y. Journal of Materials Chemistry 2009, 19, 2999.
(8) Hamann, T. W.; Farha, O. K.; Hupp, J. T. The Journal of Physical Chemistry C 2008, 112, 19756.
(9) Antila, L. J.; Heikkilä, M. J.; Mäkinen, V.; Humalamäki, N.; Laitinen, M.; Linko, V.; Jalkanen, P.; Toppari, J.; Aumanen, V.; Kemell, M.; Myllyperkiö, P.; Honkala, K.; Häkkinen, H.; Leskelä, M.; Korppi-Tommola, J. E. I. The Journal of Physical Chemistry C 2011, 115, 16720.
(10) Son, H.-J.; Wang, X.; Prasittichai, C.; Jeong, N. C.; Aaltonen, T.; Gordon, R. G.; Hupp, J. T. Journal of the American Chemical Society 2012, 134, 9537.
(11) Prasittichai, C.; Hupp, J. T. The Journal of Physical Chemistry Letters 2010, 1, 1611
(12) Goldstein, D. N.; McCormick, J. A.; George, S. M. The Journal of Physical Chemistry C 2008, 112, 19530.
(13) Hanson, K.; Torelli, D. A.; Vannucci, A. K.; Brennaman, M. K.; Luo, H.; Alibabaei, L.; Song, W.; Ashford, D. L.; Norris, M. R.; Glasson, C. R. K.; Concepcion, J. J.; Meyer, T. J. 2012, DOI: 10.1002/anie.201206882.
(14) Trammell, S. A.; Meyer, T. J. J. Phys. Chem. B 1999, 103, 104.
(15) Antila, L. J.; Heikkilä, M. J.; Aumanen, V.; Kemell, M.; Myllyperkiö, P.; Leskelä, M.; Korppi-Tommola, J. E. I. The Journal of Physical Chemistry Letters 2009, 1, 536.
(16) Norris, M. R.; Concepcion, J. J.; Glasson, C. R. K.; Fang, Z.; Ashford, D. L.; Jurss, J. W.; Templeton, J. L.; Meyer, T. J. (In preparation) 2012.
(17) Lee, S.-H. A.; Abrams, N. M.; Hoertz, P. G.; Barber, G. D.; Halaoui, L. I.; Mallouk, T. E. J. Phys. Chem. B 2008, 112, 14415.
(18) Brennaman, M. K.; Patrocinio, A. O. T.; Song, W.; Jurss, J. W.; Concepcion, J. J.; Hoertz, P. G.; Traub, M. C.; Murakami Iha, N. Y.; Meyer, T. J. ChemSusChem 2011, 4, 216.
(19) Hanson, K.; Brennaman, M. K.; Luo, H.; Glasson, C. R. K.; Concepcion, J. J.; Song, W.; Meyer, T. J. ACS Appl. Mater. Interfaces 2012, 4, 1462.
(20) Trammell, S. A.; Meyer, T. J. J. Phys. Chem. B 1999, 103, 104.

### Embodiments

Embodiment 1. An assembly comprising:
a metal oxide surface;
at least one first molecule attached to the metal oxide surface through one or more surface-linking groups,
at least one second molecule attached to the surface
wherein the second molecule is an oxide.
Embodiment 2. The assembly of embodiment 1, wherein the at least one first molecule is a chromophore or catalyst.
Embodiment 3. The assembly of any one of embodiment 1 or embodiment 2, wherein the at least one second molecule is conducting.
Embodiment 4. The assembly of any one of embodiment 1 or embodiment 2, wherein the at least one second molecule is semiconducting.
Embodiment 5. The assembly of any one of embodiment 1 or embodiment 2, wherein the at least one second molecule is insulating.
Embodiment 6. The assembly of any one of embodiments 1-5, wherein at least some of the metal oxide is in the form of nanoparticles, nanocrystals, nanocolumns, nanotubes, nanosheets, nanowires, nanotips, nanoflowers, nanohorns, nano-onions, dendritic nanowires, or a combination of two or more thereof.
Embodiment 7. The assembly of any one of embodiments 1-6, wherein the metal oxide is chosen from SnO₂, TiO₂, Nb₂O₅, SrTiO₃, Zn₂SnO₄, ZrO₂, NiO, Ta-doped TiO₂, Nb-doped TiO₂, fluorine-doped tin oxide, indium tin oxide, antimony-doped tin oxide and combinations thereof.
Embodiment 8. The assembly of any one of embodiments 1-7, wherein the surface linking group is chosen from —COOH, —PO₃H₂, —SO₃H, —OPO₃H, —OSO₃H, —PH(OH)₂, —CH(CO₂H)₂, —CH═C(CO₂H)₂, —CONHOH, —CSSH, —CSOH, and combinations thereof.
Embodiment 9. The assembly of any one of embodiments 1-8, where the at least one second molecule is chosen from: oxide dielectrics, oxide conductors, oxide semiconductors, ternary oxides, nitride dielectrics, nitride semiconductors, metallic nitrides, group II-VI semiconductors, group II-VI based phosphors, group II-V semiconductors, fluorides, CaF₂, SrF₂, MgF₂, LaF₃, and ZnF₂, elements, PbS, SnS, In₂S₃, Sb₂S₃, CuₓS, CuGaS₂, WS₂, SiC, Ge₂Sb₂Te₅, and combinations thereof.
Embodiment 10. The assembly of any one of embodiments 1-9 where the at least one second molecule is chosen from Al₂O₃, ZrO₂, and HfO₂ and combinations thereof.
Embodiment 11. The assembly of any one of embodiments 1-10, wherein the at least one first molecule is chosen from ruthenium coordination complexes, osmium coordination complexes, copper coordination complexes, porphyrins, phythalocyanines, and organic dyes, and combinations thereof.
Embodiment 12. The assembly of any one of embodiments 1-11 wherein one or more of the at least one second molecule is bonded to one or more surface linking groups.
Embodiment 13. The assembly of any one of embodiments 1-12 wherein one or more of the at least one second molecule is bonded to another second molecule.
Embodiment 14. The assembly of any one of embodiments 1-13 wherein the desorption rate constant of the at least one first molecule measured in water (k_{des}) is equal to or less than about 3.9×10⁻⁵ s⁻¹.
Embodiment 15. The assembly of any one of embodiments 1-13 wherein the desorption rate constant of the at least first one molecule measured at pH 8.5 (k_{des}) is equal to or less than about 10.9×10⁻⁵s⁻¹.
Embodiment 16. The assembly of any one of embodiments 1-13 wherein the cross surface electron diffusion coefficient (Dₐₚₚ) is equal to or less than about 1.32×10⁻¹⁰ cm²/s.
Embodiment 17. The assembly of any one of embodiments 1-13 wherein the electron ejection efficiency (φᵢₙⱼ) is equal to or greater than about 47%.
Embodiment 18. The assembly of any one of embodiments 1-13 wherein the back electron transfer rate (k_{bet}) is equal to or less than about 4.8×10⁴s⁻¹.
Embodiment 19. The assembly of any one of embodiments 1-13 wherein the electron ejection efficiency (4ᵢₙⱼ) is equal to or greater than about 47% and wherein the back electron transfer rate (k_{bet}) is equal to or less than about 4.8×10⁴s¹.
Embodiment 20. An electrode, comprising:
   the assembly of any one of embodiments 1-13.
Embodiment 21. A dye-sensitized solar cell, comprising:
   the assembly of any one of embodiments 1-13.
Embodiment 22. A dye-sensitized photoelectrosynthesis cell comprising:
   the assembly of any one of embodiments 1-13.
Embodiment 23. An assembly comprising:
a metal oxide surface comprising TiO₂;
at least one [Ru(bpy)₂(4,4′-(PO₃H₂)₂bpy)]²⁺ linked to the metal oxide surface, and at least one Al₂O₃ linked to the surface.
Embodiment 24. A method of making an assembly for harvesting light, comprising:
providing a surface comprising a metal oxide;
attaching at least one first molecule, which comprises at least one surface-linking group and at least one chromophore, to the surface through the at least one surface-linking group;
attaching at least one second molecule to the surface;
   wherein the at least one second molecule is a conductive, semiconductive, or insulating oxide.
Embodiment 25. A method of making an assembly for harvesting light, comprising:
providing a surface comprising TiO₂;
attaching at least one [Ru(bpy)₂(4,4′-(PO₃H₂)₂bpy)]²⁺ to the surface; attaching at least one Al₂O₃ to the surface.
Embodiment 26. A method of making an assembly for stabilizing a chromophore on a surface, comprising:
providing a surface comprising TiO₂;
attaching at least one [Ru(bpy)₂(4,4′-(PO₃H₂)₂bpy)]²⁺ to the surface;
attaching at least one Al₂O₃ to the surface.
Embodiment 27. A method of stabilizing a chromophore on a surface, comprising:
providing a surface comprising a metal oxide;
attaching at least one first molecule, which comprises at least one surface-linking group and at least one chromophore, to the surface through the at least one surface-linking group;
attaching at least one second molecule to the surface;
   wherein the at least one second molecule is a conductive, semiconductive, or insulating oxide.
Embodiment 28. A method of making an assembly for catalyzing a chemical reaction, comprising:
providing a surface comprising a metal oxide;
attaching at least one first molecule, which comprises at least one surface-linking group and at least one catalyst, to the surface through the at least one surface-linking group;
attaching at least one second molecule to the surface;
   wherein the at least one second molecule is a conductive, semiconductive, or insulating oxide.
Embodiment 29. A method of stabilizing an assembly for catalyzing a chemical reaction, comprising:
providing a surface comprising a metal oxide;
attaching at least one first molecule, which comprises at least one surface-linking group and at least one catalyst, to the surface through the at least one surface-linking group;
attaching at least one second molecule to the surface;
wherein the at least one second molecule is a conductive, semiconductive, or insulating oxide.

1. An assembly comprising:
a metal oxide surface;
at least one first molecule attached to the metal oxide surface through one or more surface-linking groups,
at least one second molecule attached to the surface
wherein the second molecule is an oxide.

2. The assembly of claim 1, wherein the at least one first molecule is a chromophore or catalyst.

3. The assembly of claim 1, wherein the at least one second molecule is conducting.

4. The assembly of claim 1, wherein the at least one second molecule is semiconducting.

5. The assembly of claim 1, wherein the at least one second molecule is insulating.

6. The assembly of claim 1, wherein at least some of the metal oxide is in the form of nanoparticles, nanocrystals, nanocolumns, nanotubes, nanosheets, nanowires, nanotips, nanoflowers, nanohorns, nano-onions, dendritic nanowires, or a combination of two or more thereof.

7. The assembly of claim 1, wherein the metal oxide is chosen from SnO₂, TiO₂, Nb₂O₅, SrTiO₃, Zn₂SnO₄, ZrO₂, NiO, Ta-doped TiO₂, Nb-doped TiO₂, fluorine-doped tin oxide, indium tin oxide, antimony-doped tin oxide and combinations thereof.

8. The assembly of claim 1, wherein the surface linking group is chosen from —COOH, —PO₃H₂, —SO₃H, —OPO₃H, —OSO₃H, —PH(OH)₂, —CH(CO₂H)₂, —CH═C(CO₂H)₂, —CONHOH, —CSSH, CSOH, and combinations thereof.

9. The assembly of claim 1, where the at least one second molecule is chosen from: oxide dielectrics, oxide conductors, oxide semiconductors, ternary oxides, nitride dielectrics, nitride semiconductors, metallic nitrides, group II-VI semiconductors, group II-VI based phosphors, group II-V semiconductors, fluorides, CaF₂, SrF₂, MgF₂, LaF₃, and ZnF₂, elements, PbS, SnS, In₂S₃, Sb₂S₃, CuₓS, CuGaS₂, WS₂, SiC, Ge₂Sb₂Te₅, and combinations thereof.

10. The assembly of claim 1, wherein any one of claims the at least one second molecule is chosen from Al₂O₃, ZrO₂, and HfO₂ and combinations thereof.

11. The assembly of claim 1, wherein the at least one first molecule is chosen from ruthenium coordination complexes, osmium coordination complexes, copper coordination complexes, porphyrins, phythalocyanines, and organic dyes, and combinations thereof.

12. The assembly of claim 1, wherein one or more of the at least one second molecule is bonded to one or more surface linking groups.

13. The assembly of claim 1, wherein one or more of the at least one second molecule is bonded to another second molecule.

14. The assembly of claim 1, wherein the desorption rate constant of the at least one first molecule measured in water (k_{des}) is equal to or less than about 3.9×10⁻⁵ s⁻¹.

15. The assembly of claim 1, wherein the desorption rate constant of the at least one first molecule measured at pH 8.5 (k_{des}) is equal to or less than about 10.9×10⁻⁵s⁻¹.

16. The assembly of claim 1, wherein the cross surface electron diffusion coefficient (Dₐₚₚ) is equal to or less than about 1.32×10⁻¹⁰ cm²/s.

17. The assembly of claim 1, wherein the electron ejection efficiency (φᵢₙⱼ) is equal to or greater than about 47%.

18. The assembly of claim 1, wherein the back electron transfer rate (k_{bet}) is equal to or less than about 4.8×10⁴s⁻¹.

19. The assembly of claim 1, wherein the electron ejection efficiency (φᵢₙⱼ) is equal to or greater than about 47% and wherein the back electron transfer rate (k_{bet}) is equal to or less than about 4.8×10⁴s⁻¹.

20.-22. (canceled)

23. An assembly comprising:
a metal oxide surface comprising TiO₂;
at least one [Ru(bpy)₂(4,4′-(PO₃H₂)₂bpy)]²⁺ linked to the metal oxide surface, and at least one Al₂O₃ linked to the surface.

24.-29. (canceled)
